(19) United States
(12) Patent Application Publication
(10) Pub. No.: US 2020/0106280 A1
(43) Pub. Date: Apr. 2, 2020

(54) WORKBENCH CHARGING STATION

(71) Applicant: Vector Products, Inc., Boca Raton, FL (US)

(72) Inventor: MATHEW INSKEEP, HIGHLAND BEACH, FL (US)

(21) Appl. No.: 16/587,622

(22) Filed: Sep. 30, 2019

Related U.S. Application Data
(60) Provisional application No. 62/739,748, filed on Oct. 1, 2018.

(51) Int. Cl. H02J 7/00; H01R 27/02; H01R 25/00; H01R 24/30; H01R 24/60

(52) U.S. Cl. CPC H02J 7/0052; H01R 27/02; H02J 2007/0062; H01R 24/30; H01R 24/60; H01R 25/006

(57) ABSTRACT

A charging station and storage device for preferably storing a plurality of power tools and battery packs while also charging the battery packs during storage. The battery pack can be used to connect to and power the stored power tools interchangeably, allowing users of the device access to the power tools and easy portable power capability. The disclosed device allows the battery packs to be housed and charged in the same unit that stores the various tools/devices. The device can also be provided with a light to illuminate the user's bench/work area.

This application claims the benefit of and priority to U.S. Ser. No. 62/739,748, filed Oct. 1, 2018, which application is incorporated by reference in its entirety for all purposes.

### 1. FIELD OF THE DISCLOSURE

The disclosure relates generally to charging stations and particularly to a novel multifunctional storage and charging station.

### 2. BACKGROUND

It is common for power tools to be provided with a battery power pack. Often the user may forget to charge the battery pack after use, thus resulting in the battery often being dead the next time the user goes to use the power tool. Additionally, it is also common to store each power tool separate from the storage of the other power tools, such that the storage becomes unorganized and a particular power tool that the user needs to use may be difficult to find. It is to addressing the above issues and other current issues with power tools and charging stations that the present disclosure is directed.

### SUMMARY OF THE DISCLOSURE

A novel workbench charging station (“Station”) is disclosed, with two non-limiting embodiments shown in the drawing figures. The novel Station can be capable of providing multiple tools in one compartmentalized unit. The Station can include battery packs that can connect to various tools/devices interchangeably, allowing users of the Station easy portable power capability. The battery packs can be housed and charged in the same unit that stores the various tools/devices. The Station can also be provided with a light to illuminate the user's bench/work area.

Accordingly, in a preferred embodiment a lighted, multifunctional workbench charging station can be provided. The Station can be mounted on a wall for a user's ease and can be powered by 120 Volt AC power or by any other external battery. The workbench charging station can be provided with a compartment/channel on each end where a battery pack can be stored and charged. The compartment/channels can be provided with a connector inside that connects to the battery pack to allow the battery back to be stored and charged in the compartment/channel. The connector provides an electrical connection, which charges the battery pack while it is stored in the compartment/channel.

As a non-limiting example, the connector can be a male USB connector, which connects to a female USB port on the battery pack, or a barrel connector, which connects to a pin hole connection port on the battery pack. Other electrical and/or mechanical connectors can be used and are considered within the scope of the disclosure.

Between the two end channels/compartment for preferably receiving the battery packs, there are multiple other compartment/channels for storing other portable tools/devices, such as, but not limited to, a compressor, inflator, work light, and/or power inverter, etc. These portable tools/devices can be mechanically connected and in one non-limiting embodiment can ‘click-in’ (via a track or other connection mechanism) into the compartment/channel so that they can be stored in the workbench charging station until the user desires to use the tool/device.

To use one of the stored the tools/devices, a user can remove the selected tool/device and one of the charged battery packs from their respective storage compartments in the Station. The battery pack can be mechanically and electrically connected to the tool/device, so that the battery pack powers the tool/device. In one non-limiting embodiment, the battery packs can have female 2-way USB ports and can serve as portable power devices. When coupled to the novel Station, the female 2-way USB ports of the battery pack can be exposed, allowing the battery pack to be used to power external devices simultaneously, while its own battery is being charged via the electrical connection to the novel Station. The battery packs' USB ports can be used to power devices, such as handheld portable electronic devices, as a standalone portable power device or while connected to another tool/device, other uses are also considered within the scope of the disclosure.

One non-limiting power bank/battery booster can be a lithium-ion battery booster/power bank (See FIG. 3 which provides certain information, features and instructions for using this non-limiting battery pack).

Other features can also be added to the Station, including features not requiring electrical power sources. Theses features are also considered within the scope of the disclosure.

As mentioned above, a light can be provided to illuminate the area around the station. An off/switch can be provided for turning the light on and off. In one embodiment, the light can be a LED light or LED light array.

### BRIEF DESCRIPTION OF THE DRAWINGS

FIG. 1 is a first view of a non-limiting embodiment for the workbench charging station in accordance with the present disclosure; and

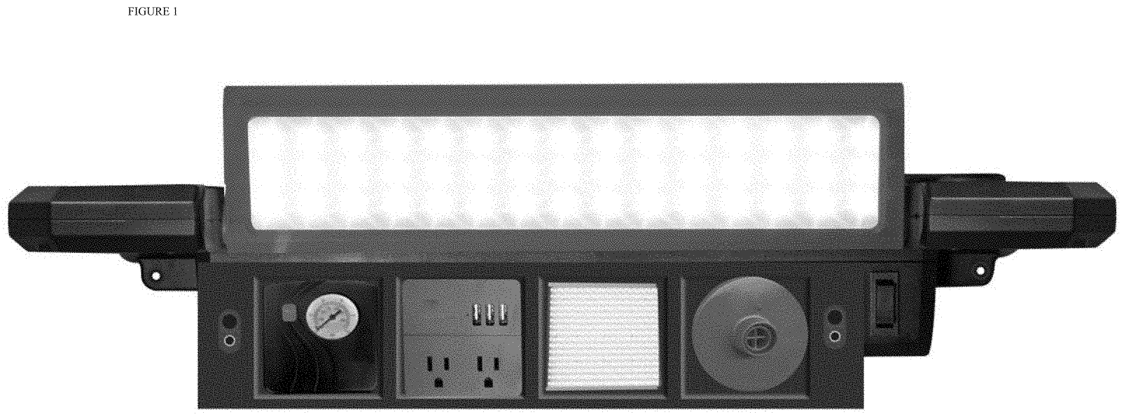

FIG. 2 is a second view of a non-limiting embodiment for the workbench charging station.

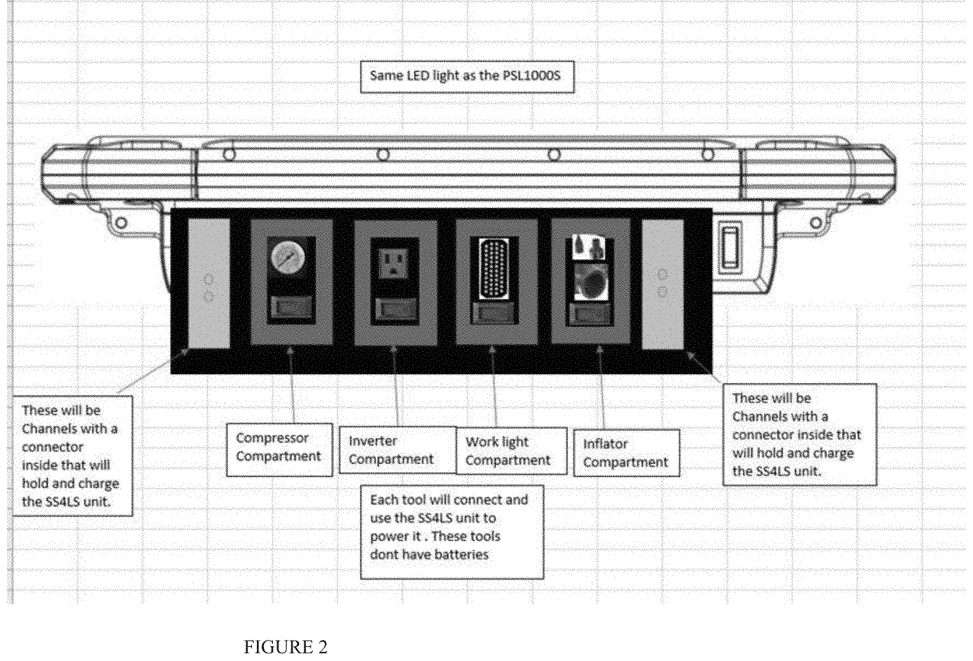

### DETAILED DESCRIPTION

A novel workbench charging station (“Station”) is disclosed, with two non-limiting embodiments shown in the drawing figures. The novel Station can be capable of providing multiple tools in one compartmentalized unit. The Station can include battery packs that can connect to various tools/devices interchangeably, allowing users of the Station easy portable power capability. The battery packs can be housed and charged in the same unit that stores the various tools/devices. The Station can also be provided with a light to illuminate the user's bench/work area.

Accordingly, in a preferred embodiment a lighted, multifunctional workbench charging station can be provided. The Station can be mounted on a wall for a user's ease and can be powered by 120 Volt AC power or by any other external battery. The workbench charging station can be provided with a compartment/channel on each end where a battery pack can be stored and charged. The compartment/channels can be provided with a connector inside that connects to the battery pack to allow the battery back to be stored and charged in the compartment/channel. The connector provides an electrical connection, which charges the battery pack while it is stored in the compartment/channel.

As a non-limiting example, the connector can be a male USB connector, which connects to a female USB port on the battery pack, or a barrel connector, which connects to a pin hole connection port on the battery pack. Other electrical and/or mechanical connectors can be used and are considered within the scope of the disclosure.

Between the two end channels/compartment for preferably receiving the battery packs, there are multiple other compartment/channels for storing other portable tools/devices, such as, but not limited to, a compressor, inflator, work light, and/or power inverter, etc. These portable tools/devices can be mechanically connected and in one non-limiting embodiment can ‘click-in’ (via a track or other connection mechanism) into the compartment/channel so that they can be stored in the workbench charging station until the user desires to use the tool/device.

To use one of the stored the tools/devices, a user can remove the selected tool/device and one of the charged battery packs from their respective storage compartments in the Station. The battery pack can be mechanically and electrically connected to the tool/device, so that the battery pack powers the tool/device. In one non-limiting embodiment, the battery packs can have female 2-way USB ports and can serve as portable power devices. When coupled to the novel Station, the female 2-way USB ports of the battery pack can be exposed, allowing the battery pack to be used to power external devices simultaneously, while its own battery is being charged via the electrical connection to the novel Station. The battery packs' USB ports can be used to power devices, such as handheld portable electronic devices, as a standalone portable power device or while connected to another tool/device, other uses are also considered within the scope of the disclosure.

One non-limiting power bank/battery booster can be a lithium-ion battery booster/power bank such as the one sold with the STANLEY POWERTOGO product. Other battery packs/power banks can also be used and housed and charged with the one or more of the compartments designated for charging and all are considered with the scope of the disclosure.

Any conventional battery charging technology/circuitry/electronics can be used for charging the power packs once the secured within the charging compartments and all are considered within the scope of this disclosure. Additionally, any conventional technology/circuitry/electronics for having or powering a light that can be optionally provided with the workbench can also be used and all are considered within the scope of the disclosure.

Other features can also be added to the Station, including features not requiring electrical power sources. These features are also considered within the scope of the disclosure.

As mentioned above, a light can be provided to illuminate the area around the station. An off/switch can be provided for turning the light on and off. In one embodiment, the light can be a LED light or LED light array.

Applicant also incorporates by reference the entire disclosures and illustrations as if set forth herein in its following U.S. patents and published patent application”, as if the disclosures and illustrations were fully set forth herein, as well as providing non-limiting examples of charging technology, two-USB capabilities technology that can be used with the instant disclosure:
1. U.S. application Ser. No. 15/378,187 filed Dec. 14, 2016 entitled “Battery Booster With Integrated Modular Compressor and Inverter”;
2. U.S. Pat. No. 10,110,055, issued Oct. 23, 2018 entitled “Fast Charging High Energy Storage Capacitor System Jump Starter”;
3. U.S. Pat. No. 9,843,208, issued Dec. 12, 2017, entitled High Power rechargeable flashlight with two way universal serial bus”;
4. U.S. application Ser. No. 15/984,789, filed May 21, 2018, entitled “Battery Charger with Detachable Battery”;
5. U.S. application Ser. No. 15/378,142, filed Dec. 14, 2016, entitled “High Power Rechargeable Spotlight with Two Way Universal Serial Bus”;
6. U.S. application Ser. No. 15/349,324, filed Nov. 11, 2016, entitled “Portable Power Station Unit With Two Way Universal Serial Bus”;
7. U.S. application Ser. No. 15/440,079, filed Feb. 23, 2017, entitled “Portable Power Tool Capacitor Jump Start System”;
8. U.S. application Ser. No. 14/038,503, filed Sep. 26, 2013, entitled “High-Efficiency Battery Charger”;
9. U.S. application Ser. No. 13/490,599, filed Jun. 7, 2012, entitled “Battery With Integrated Power Inverter”; and
10. U.S. application Ser. No. 12/788,040, filed May 26, 2010, entitled “Multi-Purpose Battery Jump Starter and Reconditioner”.

Though the battery packs stored within the charging compartments are preferably used with the power tools stored within the other compartments, it is also within the scope of the disclosure that the battery packs can also be used to charge other power tools and power devices not stored within the disclosed workbench charging station. Similarly, though the stored power tools/devices are preferably powered using one or more of the power packs also stored and charged by the disclosed workbench charging station, it is also within the scope of the disclosure that the power tools/devices can also be powered using other battery/power packs.

It should be understood that the exemplary embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from their spirit and scope.

All components of the Station and their locations, electronic communication methods between the system components, wiring, attachment or securement mechanisms, mechanical and electrical connections, dimensions, values, shapes, materials, light sources, light bulbs, charging methods, battery types, tools and devices that can be used therewith, etc. discussed above or shown in the drawings, if any, are merely by way of example and are not considered limiting and other component(s) and their locations, electronic communication methods, wiring, attachment or securement mechanisms, mechanical and electrical connections, dimensions, values, shapes, materials, light sources, light bulbs, charging methods, battery types, tools and devices that can be used therewith, etc. can be chosen and used and all are considered within the scope of the disclosure.

The benefits, advantages, solutions to problems, and any element(s) that may cause any benefit, advantage, or solution to occur or become more pronounced are not to be construed as a critical, required, or essential features or elements of any or all the claims.

Unless feature(s), part(s), component(s), characteristic(s) or function(s) described in the specification or shown in the drawings for a claim element, claim step or claim term specifically appear in the claim with the claim element, claim step or claim term, then the inventor does not consider such feature(s), part(s), component(s), characteristic(s) or function(s) to be included for the claim element, claim step or claim term in the claim when and if the claim element, claim step or claim term is interpreted or construed. Similarly, with respect to any “means for” elements in the claims, the inventor considers such language to require only the minimal amount of features, components, steps, or parts from the specification to achieve the function of the “means for” language and not all of the features, components, steps or parts describe in the specification that are related to the function of the “means for” language.

While the novel Station has been described and disclosed in certain terms and has disclosed certain embodiments or modifications, persons skilled in the art who have acquainted themselves with the disclosure, will appreciate that it is not necessarily limited by such terms, nor to the specific embodiments and modification disclosed herein. Thus, a wide variety of alternatives, suggested by the teachings herein, can be practiced without departing from the spirit of the disclosure, and rights to such alternatives are particularly reserved and considered within the scope of the disclosure.

What is claimed is:

1. A charging station and storage device, comprising:
a housing defining a plurality of compartments,
wherein the plurality of compartments includes a first compartment and a second compartment;
a first electrical connector accessible within the first compartment of the plurality of compartments;
wherein the second compartment of the plurality compartments provided with an attachment mechanism for removably securing a first power functional tool or device within the second compartment,
wherein the first power functional tool or devices is disconnected from a power source when disposed and secured within the second compartment;
battery charging circuitry or electronics disposed within the housing and in communication with the first electrical connector; wherein the battery charging circuitry or electronics delivers power from an external power source through the first electrical connector to a tool battery pack disposed within the first compartment and electrically connected to the first electrical connector;
wherein in use a tool battery pack is removably disposed within the first compartment and in electrical communication with the battery charging circuitry or electronics through removable connection with the first electrical connector in order to charge the tool battery pack and when a user wishes to use the first power functional tool or device the user removes the first power functional tool or device from its current location within the second compartment and removes the tool battery pack from the its current location within the first compartment and secures the tool battery pack to the first power functional tool or device to provide power to the first power functional tool or device.

2. The charging station and storage device of claim 1 wherein the housing is adapted for securement or mounting to a wall or structure.

3. The charging station and storage device of claim 1 wherein the external power source is a 120 Volt AC power source or an external battery.

4. The charging station and storage device of claim 1 wherein the first electrical connector is a USB connector.

5. The charging station and storage device of claim 1 further comprising at least one battery pack, a first of the at least one battery pack having an electrical connector configured for mechanically and electrically mating with the electrical connector contained within the first compartment, wherein when not in use to power a power tool, the first battery pack stored within the first compartment in order to be charged through the mating connection of the first electrical connector and the mating electrical connector of the first battery pack.

6. The charging station and storage device of claim 5 wherein the first battery pack having a two-way USB connector or port which is externally accessible while the first battery pack is stored and secured within the first compartment to allow the first battery pack to be used for powering an external electrical device while the first battery pack is also being charged through the electrical connection of the first battery pack within the first compartment.

7. The charging station and storage device of claim 1 wherein the housing having an upper surface sufficient in size to serve as a work area or work bench.

8. The charging station and storage device of claim 1 further comprising one or more light bulbs and circuitry contained within the housing for energizing the one or more light bulbs, the one or more light bulbs are externally visible for lighting an area around the housing when the one or more light bulbs are energized, the circuitry including an external accessible switch for turning the one or more light bulbs on and off.

9. The charging station and storage device of claim 8 wherein the one or more light bulbs are one or more LED light bulbs.

10. A charging station and storage device, comprising:
a housing defining a plurality of compartments,
wherein the plurality of compartments includes a first compartment and a last compartment and one or more middle compartments;
a first electrical connector accessible within the first compartment;
a second electrical connector accessible within the last compartment;
wherein each compartment of the one or more middle compartments provided with an attachment mechanism for removably securing a power functional tool or device within;
wherein the power functional tool or device is disconnected from a power source when disposed and secured within one compartment of the one or more compartment;
battery charging circuitry or electronics disposed within the housing and in communication with the first electrical connector and the second electrical connector; wherein the battery charging circuitry or electronics delivers power from an external power source through the first electrical connector to a first tool battery pack disposed within the first compartment and electrically connected to the first electrical connector and through the second electrical connector to a second tool battery pack disposed within the last compartment and electrically connected to the second electrical connector;
wherein in use a tool battery pack is removably disposed within at least the first compartment and in electrical communication with the battery charging circuitry or electronics through removable connection with the first electrical connector in order to charge the tool battery pack or at least the last compartment and in electrical communication with the battery charging circuitry or electronics through removable connection with the second electrical connector in order to charger the tool battery pack and when a user wishes to use a power functional tool or device the user removes the power functional tool or device from its current location within one compartment of the one or more middle compartments and removes the tool battery pack from the its current location within the first compartment or last compartment and secures the tool battery pack to the first power functional tool or device to provide power to the power functional tool or device.

11. The charging station and storage device of claim 10 wherein the housing is adapted for securement or mounting to a wall or structure.

12. The charging station and storage device of claim 10 wherein the external power source is a 120 Volt AC power source or an external battery.

13. The charging station and storage device of claim 10 wherein the first electrical connector is a first USB connector and the second electrical connector is a second USB connector.

14. The charging station and storage device of claim 10 further comprising a first battery pack having an electrical connector configured for mechanically and electrically mating with the first electrical connector contained within the first compartment and a second battery back having an electrical connector configured for mechanically and electrically mating with the second electrical connector contained within the last compartment; wherein when not in use to power a power tool the first battery pack is stored within the first compartment in order to be charged through the mating connection of the first electrical connector and the mating electrical connector of the first battery pack and the second battery pack is stored within the second compartment in order to be charged through the mating connection of the second electrical connector and the mating electrical connector of the second battery pack.

15. The charging station and storage device of claim 14 wherein the first battery pack having a two-way USB connector or port which is externally accessible while the first battery pack is stored and secured within the first compartment to allow the first battery pack to be used for powering an external electrical device while the first battery pack is also being charged through the electrical connection of the first battery pack within the first compartment and the second battery pack having a two-way USB connector or port which is externally accessible while the second battery pack is stored and secured within the last compartment to allow the second battery pack to be used for powering an external electrical device while the second battery pack is also being charged through the electrical connection of the second battery pack within the last compartment.

16. The charging station and storage device of claim 15 wherein the housing having an upper surface sufficient in size to serve as a work area or work bench.

17. The charging station and storage device of claim 10 further comprising one or more light bulbs and circuitry contained within the housing for energizing the one or more light bulbs, the one or more light bulbs are externally visible for lighting an area around the housing when the one or more light bulbs are energized, the circuitry including an external accessible switch for turning the one or more light bulbs on and off.

18. The charging station and storage device of claim 17 wherein the one or more light bulbs are one or more LED light bulbs.
